(19) United States
(12) Patent Application Publication
(10) Pub. No.: US 2012/0152464 A1
(43) Pub. Date: Jun. 21, 2012

(54) Rotational application device for the adherence of bridging materials in angular applications

(76) Inventor: Richard W. Hardman, Bellingham, WA (US)

(21) Appl. No.: 13/374,167

(22) Filed: Dec. 14, 2011

Related U.S. Application Data
(60) Provisional application No. 61/459,825, filed on Dec. 20, 2010.

(51) Int. Cl. B32B 37/00

(52) U.S. Cl. 156/580

(57) ABSTRACT

An application device which ensures a predetermined angular surface when applied over imperfections encountered within the substrate.

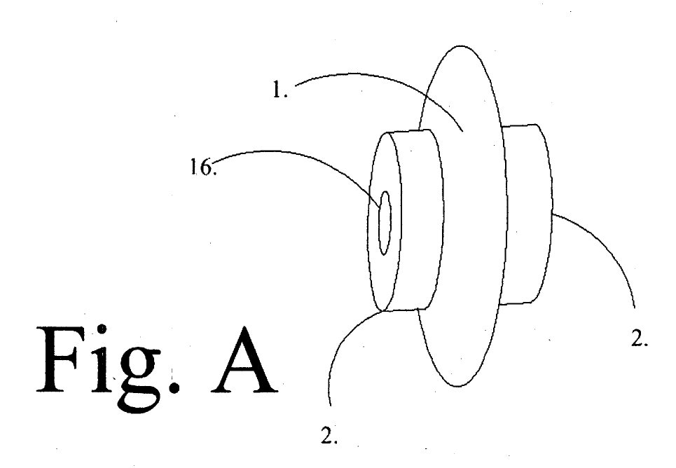

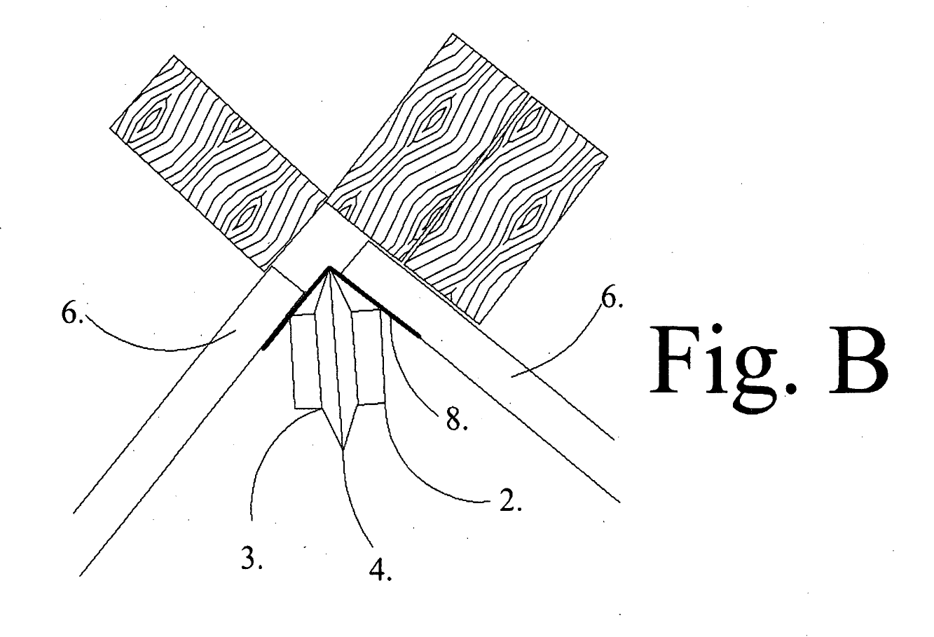

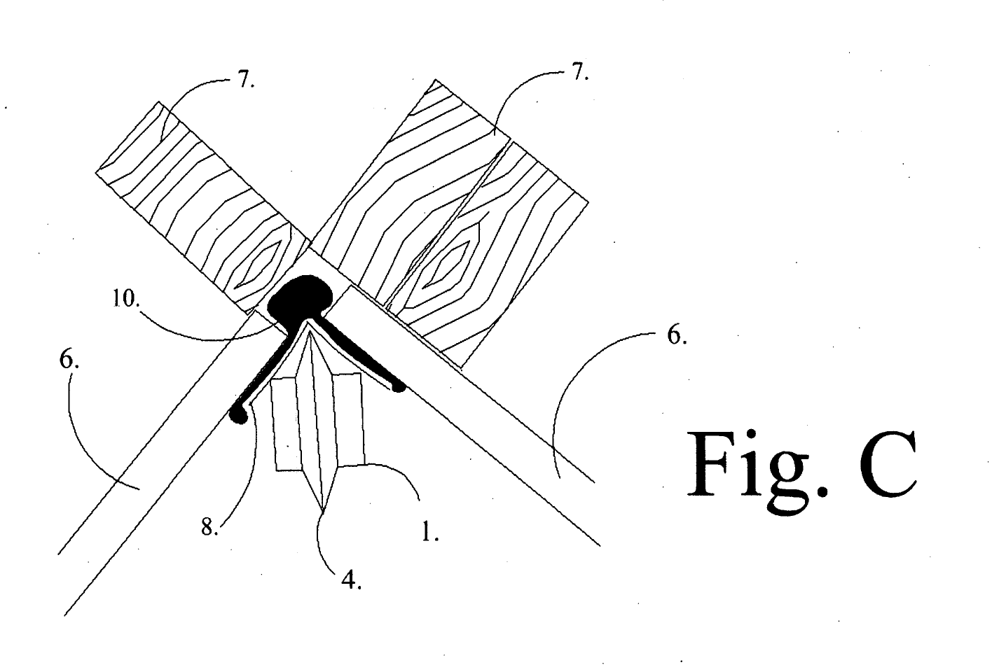

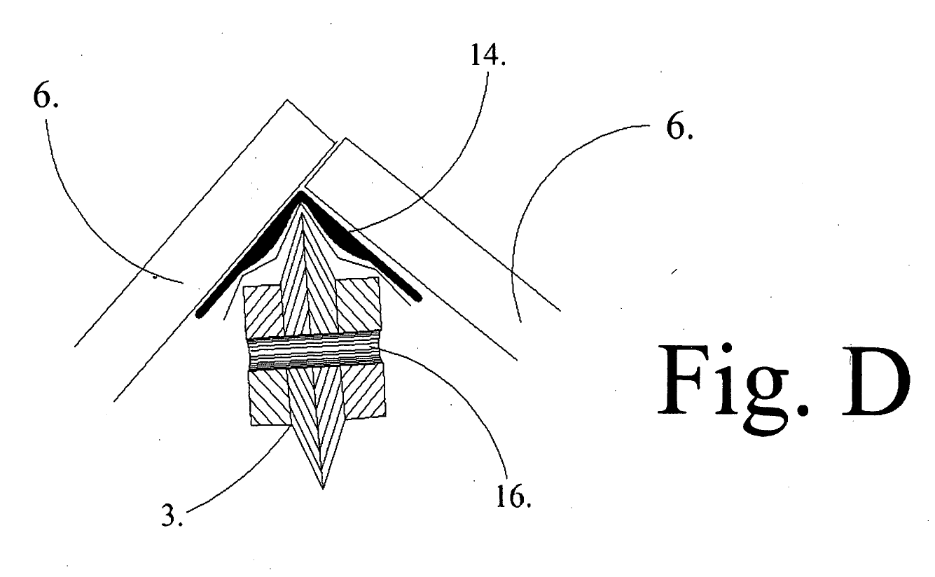

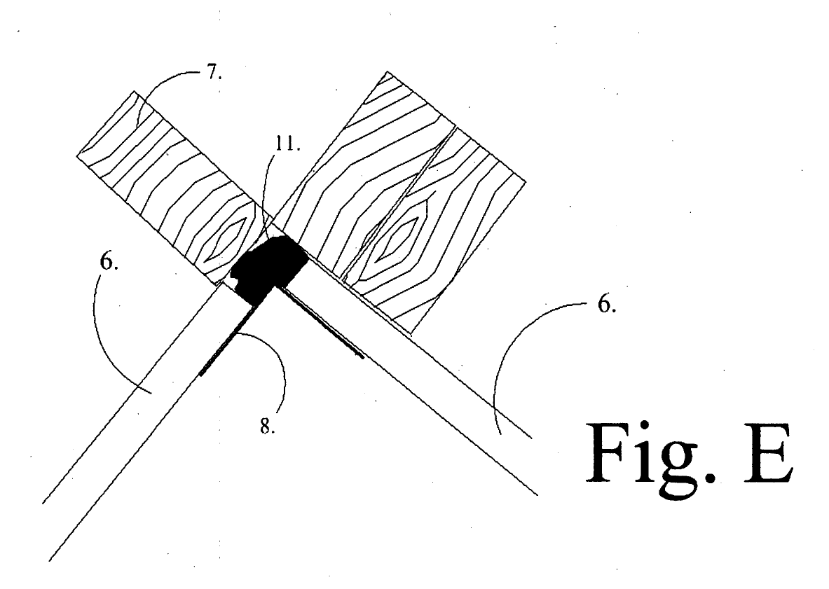

### CROSS REFERENCE TO RELATED APPLICATION

I have filed a Provisional Patent Application #61/459,825 Filed Dec. 20, 2010

### BACKGROUND OF THE INVENTION

The present embodiment provides an apparatus for the installation of bridging materials over angular surfaces disallowing the need for structural mating surfaces to support the inner areas of tapes or other bridging materials. More particularly, the embodiment provides an apparatus that allows for a pocket of embedment adhesive to be shaped behind the bridging material during the application process and does not squeeze adhesive from behind the mating material during the installation process and leaves a rigid angular surface after said adhesives have hardened. In addition the apparatus can be used singularly or in conjunction with additional versions of itself and can be used as an accessory to application equipment.

### SUMMARY OF THE INVENTION

My invention provides the user with an improved method for applying various tapes or bridging materials over areas with substandard surfaces such as gaps and crevices left between wall panels as is often encountered during the application process. Current technology has three basic design weaknesses, first, unless the user has a rotational device for applying the materials, the process is slow and tedious as the installer is required to apply the tape or other material over the inner crack in a sectional method as can only be done when applying by hand. Secondly, when using automatic taping tools with a single disk configuration, there are no secondary edges to remain on the wall surfaces which causes the tape to be stuffed into cracks whereby the operator must discontinue the application process to manually remove the material from within the crack and begin the application of new material to that same area again. Thirdly, with the standard disk type of roller there is no advantage to mounting several wheels along a plane to rapidly roll over newly applied bridging material which increases production as well as forming a perfect angle over empty spaces left between the wall panels. Forthly, some older technology wheels were a conical shape which did not allow for a reservoir which traps embedment adhesive behind the bridging material. With no embedment reservoir, the previous wheels forced adhesive out from behind the bridging material Which resulted in large areas without adhesive and caused large areas of tape to eventually pull away as they had no adhesive to adhere them it to the wall panels underneath.

My invention has the uniqueness of outer riding edges which ride on the surfaces of the bridging material and continue to roll over places in the subsurface where there is no support for the tradition creaser wheels.

In general, my invention benefits from the physical characteristics of a multiple contact point roller which contains in its design the ability to encapsulate embedment adhesive in various areas behind the surface of the bridging material whereby it allows a constant flow of embedment adhesive to the application of the bridging material while it's outer creasing means and rotational pressure provides a geometrical surface which forms a perfect angle regardless of whether the underlying wall panels were fitted properly or not.

### ALTERNATE DESIGNS

The apparatus with its geometrical shape as stated in the preceding sections has a wide variety of alternative methods of embodying the invention as described below. While this section offers additional variations of design, they should in no way be interpreted as encompassing all possible designs or composition alterations or substitutions.

### DESCRIPTION OF THE DRAWING FIGURES

I have included the following drawings to further define my invention.

Fig. A: is an illustration of the device demonstrating the relationship between the rotational pressure means which form a concentric angle along the plane of application.

Fig. B: demonstrates a further example of the relationship between the outer creasing edge and the secondary pressure means of the invention in proximity to the covering material as it is typically applied to an angled wall surface with gaps remaining in the substrate panels as is common during the application process.

Fig. C: demonstrates the relationship between the invention and bridging material to an embedment adhesive which is formed behind the bridging material and between the wall panels.

Fig. D: illustrates the way a pocket of embedment adhesive is formed as provided by the rotational directive of the invention formed in the embedment adhesive during the application process within the angular disposition of the invention along with a longitudinal perspective of the centralized rotating axis located at the central point of the inventions outermost circumferential position.

Fig. E: is a perspective of the applied bridging material in its final stage whereby the embedment adhesive has hardened to the bridging material and filling the recessed areas of the wall surfaces resulting in a completed inner angle conforming to the initial design requirements of the design engineer.

### SPECIFICATIONS

Fig. A is a view of the rotational device 1 with spacial relationships between its centralized rotating axis 16 and rotational pressure means 2.

Fig. B is a view of the invention in relation to the applied bridging material 8 and recessed angular cavity 3 illustrating the benefits of the inventions outer creasing means 4 as it forms an angle for the bridging material 8 with its rotational pressure means 2 over the gap left in the wall panel 6.

Fig. C is a top view of the apparatus as it encounters a typical application where the wall panel 6 is mounted to fixed wall support 7 with a gap left between the panels whereby the embedment adhesive 10 is squeezed into the open cavity left during the installation process and behind the bridging material 8.

Fig. D illustrates the additional adhesive material 14 that is formed within the inventions recessed angular cavity 3 over the wall panel 6 with a longitudinal view of the centralized rotating axis 16 centrally located within the body of the invention.

Fig. E illustrates the completed application of the bridging material 8 onto the wall panels 6 where the embedment adhesive has solidified into a recessed adhesive pocket 11 forming a rigid angular plane.

I claim:

1. A rotational apparatus for forming bridging materials over angular surfaces which comprises:
1) A plurality of embedding means located in proximity to form a predetermined angular disposition;
2) Said plurality of embedding means being circumferentially positioned around a centralized rotating axis;
3) Said plurality of embedding means having an extended reference;
Whereby said embedding means create a consistently formed surface during the application of covering materials over panel surfaces regardless of gaps and varied imperfect conditions of the covered substrate.
